(19) United States
(12) Patent Application Publication
(10) Pub. No.: US 2026/0119182 A1
(43) Pub. Date: Apr. 30, 2026

(54) System and Method for Single Instruction, Multiple Data (SIMD) Enhancements of ARM64 Processors

(71) Applicant: Microsoft Technology Licensing, LLC, Redmond, WA (US)

(72) Inventor: KS Huang, Redmond, WA (US)

(21) Appl. No.: 18/930,526

(22) Filed: Oct. 29, 2024

(51) Int. Cl. G06F 9/38

(52) U.S. Cl. CPC G06F 9/3887; G06F 9/30036; G06F 9/30038; G06F 15/8007

(57) ABSTRACT

A method, computer program product, and computing system for processing a portion of data using an ARM64 processor. The portion of data is determined to be unaligned to byte boundaries. The portion of data is unpacked from a single multi-bit word into multiple fixed bit output by placing the portion of data at a byte boundary between the multiple fixed bit outputs.

### BACKGROUND

Different processor architectures provide different capabilities and constraints. For example, two of the more popular processor architectures are AMD64/“x86-64”/“Intel 64” and ARM64. AMD64 refers to a 64-bit processor architecture used by AMD® and Intel® and is widely used in desktop machines, servers, and cloud storage systems. AMD64 processors have broad software support but involve higher power consumption in many scenarios. ARM64 refers to an Advanced Reduced Instruction Set Computing (RISC) Machine architecture that is developed by ARM Holdings and is prevalent in mobile devices and is increasingly used in servers. The “64” in ARM64 refers to the architecture's 64-bit processing capability. ARM64 processors known for energy efficiency but have limited software compatibility. As software developers seek to bridge the gap between AMD64 processors and ARM64 processors, many performance-based issues, specifically operations using single instruction, multiple data (SIMD), prevent software applications from operating consistently across both architectures.

### BRIEF DESCRIPTION OF THE DRAWINGS

FIG. 1 is a flow chart of one implementation of a single instruction, multiple data (SIMD) enhancement process;

FIG. 2 is a diagrammatic view of a storage system according to one implementation of the SIMD enhancement process;

FIGS. 3-6 are diagrammatic views of the SIMD enhancement process unpacking an unaligned portion of data into a plurality of byte aligned outputs;

FIG. 7 is a flow chart of one implementation of a SIMD enhancement process;

FIG. 8 is a diagrammatic view of the SIMD enhancement process performing hierarchical aggregation when processing a data access request;

FIG. 9 is a flow chart of one implementation of a SIMD enhancement process;

FIG. 10 is a diagrammatic view of the SIMD enhancement process converting a bitmap of data addressing into a bytemap for processing data access requests on an ARM64 processor; and

FIG. 11 is a diagrammatic view of computer system and the SIMD enhancement process coupled to a distributed computing network.

Like reference symbols in the various drawings indicate like elements.

### DETAILED DESCRIPTION OF THE EMBODIMENTS

Implementations of the present disclosure provide software-based enhancements to ARM64 processors to allow ARM64 processors to perform similarly to AMD64 processors, especially using advancements in single instruction, multiple data (SIMD) processes within AMD64 processors. For example, when data is not aligned to byte boundaries and packed into sixty-four bits words, it requires unpacking the data before further processing. Due to the lack of advanced bit processing instruction for ARM64 processors, the SIMD enhancement process performs bit unpacking using byte shuffling and bit shifting. Generally, unaligned data can cross two bytes even if data size is less than 8 bits, for better efficiency, it's common that unpacking supports 16 bits target size regardless original packed size. Accordingly, this challenge within the ARM64 processor results in performance degradation for any software application using the ARM64 processor for performance critical applications.

Additionally, when addressing these unaligned portions of data, the SIMD enhancement uses a dual unpack technique to repurpose double size unpacking to unpack double size data for the first half, on purpose placing data at byte boundary to cut in half and split them up. The SIMD enhancement process determines that a portion of data is unaligned to byte boundaries and unpacks the data from a single multi-bit word into multiple fixed bit output by placing the portion of data at a byte boundary between the multiple fixed bit outputs. As will be discussed in greater detail below, the SIMD enhancement process requires an additional processing step and doubles the output data. However, the SIMD enhancement process improves throughput (e.g., by more than 30%).

In another example, when processing aggregation operations, (e.g., operations that find a min/max, accumulate a sum, determine a population count, etc.) against a large contiguous buffer, a sequential ordinary “for” loop is a straightforward approach, but is inefficient. Accordingly, AMD64 processors leverage SIMD to divide a buffer into multiple lanes to process data up to a vector size in each iteration. Compared to scalar aggregation, SIMD can boost performance “N” times faster, where “N” is the lane count, however the nature of aggregation is to update the result in each iteration and create a dependency between operations; especially when processors have more than one execution pipeline and this dependency will stop overall performance from scaling up furthermore. However, ARM64 processor cores do not provide more than one-hundred twenty-eight bits as a SIMD vector size.

As will be described in greater detail below, implementations of the present disclosure process a request to access data from a storage system using an ARM64 processor and identify a plurality of individual operations within the request. The SIMD enhancement process processes the plurality of individual operations using hierarchical aggregation of the plurality of individual operations within a plurality of single instruction, multiple data (SIMD) registers of the ARM64 processor. Accordingly, implementations of the present disclosure allow for greater throughput in ARM64 processors by filling execution pipelines with hierarchically aggregated operations without the need for a physically wider vector size (as in AMD64 processors).

Further, regular data addressing provides byte level granularity, bit level lookup (in a bitmap) usually requires two steps of data accessing: byte or higher level locate and use bitmask to isolate the bit interesting. With converting the bitmap for a bytemap (all zeros or all ones to present one bit in a byte) in advance, the lookup requires only one step: locate to corresponding byte without further processing. The SIMD enhancement process processes a bitmap defining an address for data within a storage system using an ARM64 processor and converts the bitmap to a bytemap within a single instruction, multiple data (SIMD) register of the ARM64 processor. A request is processed to access the data by using the bytemap to identify the address for the data within the storage system. Accordingly, by converting the bitmap to a bytemap and loading it into SIMD register(s) and performing lookup via SIMD instruction not only allows bitmap lookup in parallel, but also minimize the lookup overhead. In some implementations, this approach is twenty times faster than scalar implementations.

Accordingly, implementations of the present disclosure provide software-based enhancements to the limitations in ARM64 processors to provide comparable performance as AMD64 processors. Specifically, by providing instructions to direct the ARM64 processor when processing requests for software applications, ARM64 processor performance is improved, and software application performance is consistent across ARM64 and AMD64 processor architectures.

The details of one or more implementations are set forth in the accompanying drawings and the description below. Other features and advantages will become apparent from the description, the drawings, and the claims.

### The Single Instruction, Multiple Data (SIMD) Enhancement Process

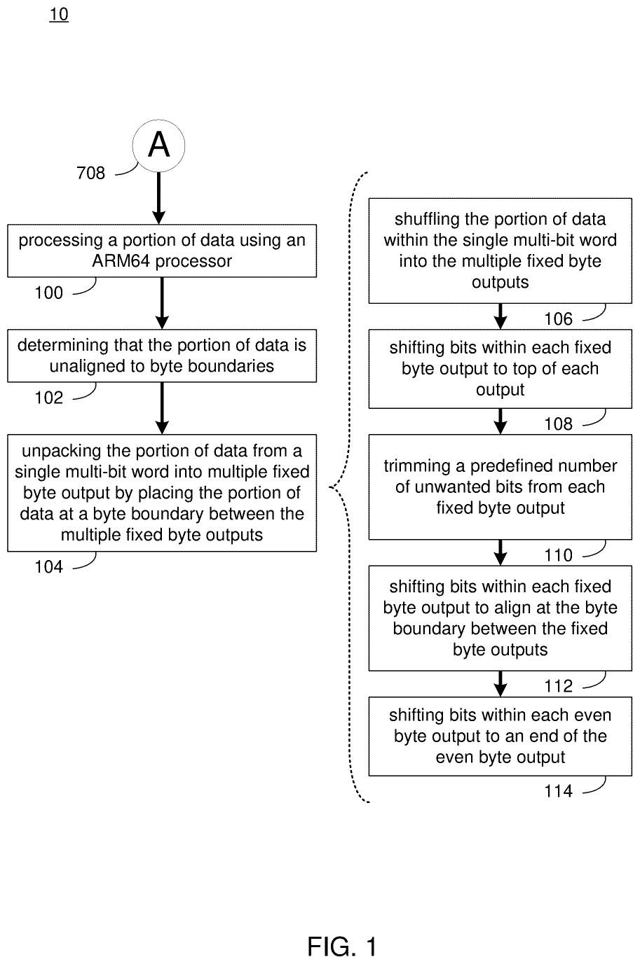

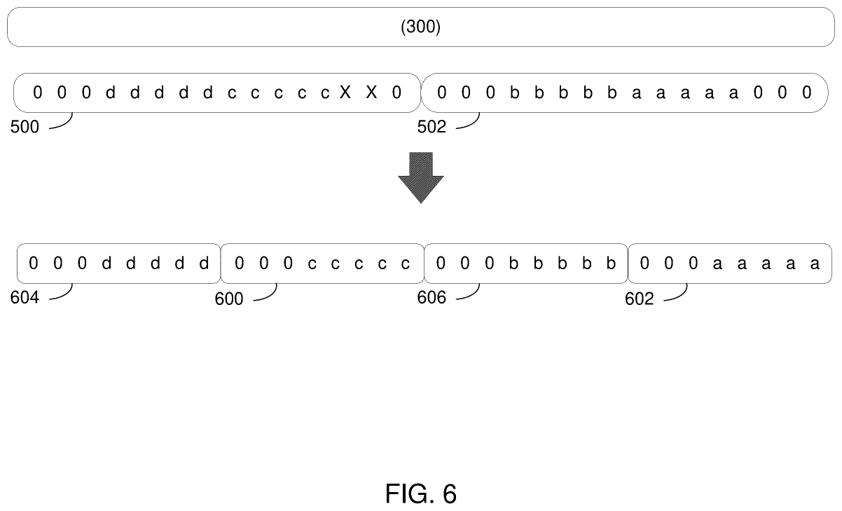

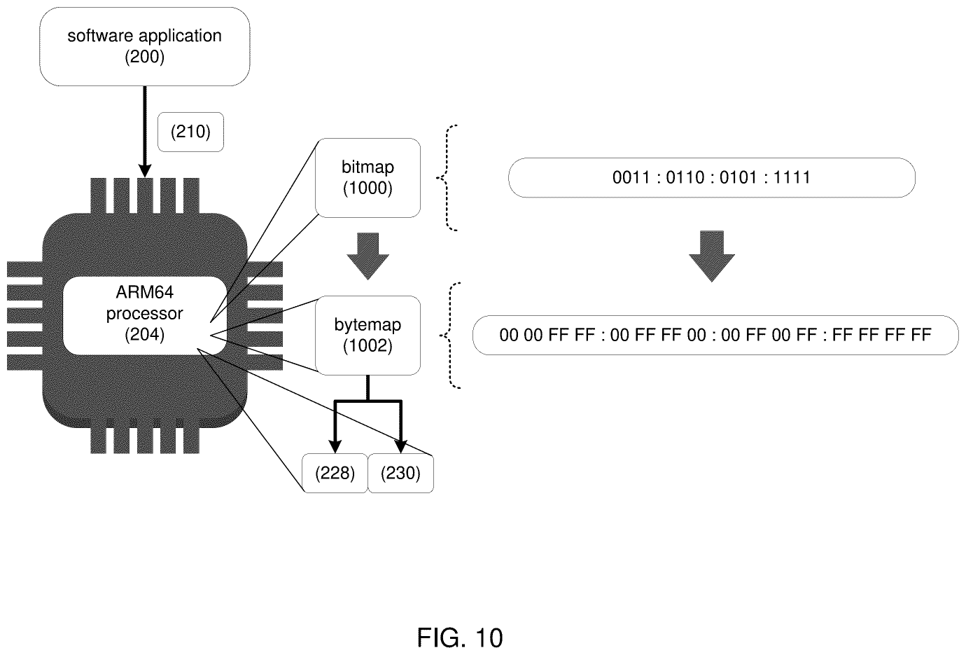

Referring to FIGS. 1-10, SIMD enhancement process 10 processes 100 a portion of data using an ARM64 processor. The portion of data is determined 102 to be unaligned to byte boundaries. The portion of data is unpacked 104 from a single multi-bit word into multiple fixed bit output by placing the portion of data at a byte boundary between the multiple fixed bit outputs.

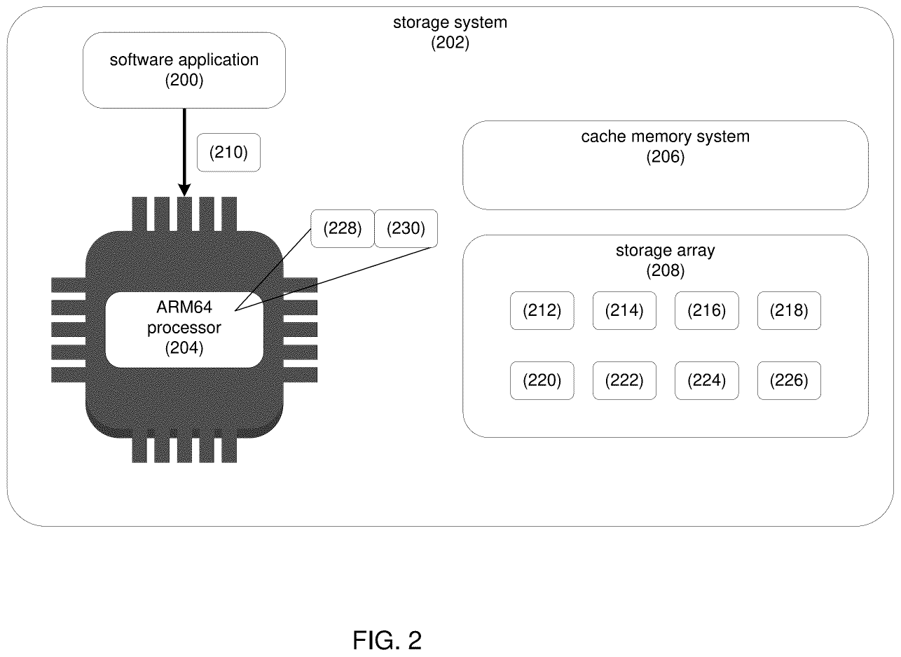

In some implementations, SIMD enhancement process 10 processes 100 a portion data using an ARM64 processor. Referring also to FIG. 2, suppose a software application (e.g., software application 200) is interacting with a storage system (e.g., storage system 202) that includes an ARM64 processor (e.g., ARM64 processor 204), a cache memory system (e.g., cache memory system 206), and a memory system (e.g., memory system 208). In one example, storage system 202 is a cloud-based storage system that provides data storage in which data is stored on servers in various, off-suite locations. The servers are maintained by a provider who is responsible for hosting, managing, and securing data stored on its infrastructure. In one example, each cloud-based storage system includes various computing devices that access cloud-based storage resources to store and retrieve data within the cloud-based storage system. Cloud-based storage resources includes hard disk (HD) storage capacity, solid-state disk (SSD) storage capacity, and/or virtual storage devices.

In some implementations, software application 200 provides various data access requests (e.g., access request 210). Examples of access request 210 include a data write request (e.g., a request that content be written to storage system 202) and a data read request (i.e., a request that content be read from storage system 202). During operation of storage system 202, content to be written to storage system 202 is processed by ARM64 processor 204. In this example, memory system 208 includes various portions of data stored or referenced thereon (e.g., where the data stored in memory system 208 is represented generally by data portions 212, 214, 216, 218, 220, 222, 224, 226).

As discussed above, ARM64 is an Advanced Reduced Instruction Set Computing (RISC) Machine (ARM) architecture that is developed by ARM Holdings and is prevalent in mobile devices and is increasingly used in servers. The “64” in ARM64 refers to the architecture's 64-bit processing capability. As will be discussed in greater detail below, ARM64 differs from AMD64 by allowing greater control and configuration of the processing capability of ARM64 processor 204 compared to AMD64 processors. For example, AMD64 includes many automated processing approaches that assist software applications to enhance their performance. While the physical hardware of ARM64 is similarly capable, ARM64 is not as “intuitive” to initiate similar automated processing approaches. Accordingly, SIMD enhancement process 10 provides approaches for instructing ARM64 processor 204 to provide similar functionality for software application 200 relative to AMD64 processors. In this manner, SIMD enhancement process 10 normalizes distinctions in the operation of software application 200 on ARM64 processor 204 and an AMD64 processor.

In some implementations, SIMD enhancement process 10 addresses distinctions in single instruction, multiple data (SIMD) hardware and/or software that enable ARM64 processors to provide similar SIMD functionality as AMD64 processors. For instance and in some implementations, ARM64 processor 204 includes one or more SIMD registers (e.g., SIMD registers 228, 230). A SIMD register in an ARM64 processor is a specialized data storage unit designed for single instruction, multiple data (SIMD) processing. ARM64 includes 32 SIMD registers, each 128 bits wide, referred to as NEON registers. SIMD allows for the simultaneous processing of multiple data elements using a single instruction, significantly enhancing throughput and efficiency.

For example, one instruction can operate on four 32-bit integers at once. NEON supports various data types, including integers and floating-point numbers, enabling optimization for specific applications like multimedia processing or machine learning. ARM64 provides a set of SIMD instructions that can perform operations such as addition, subtraction, and multiplication across all elements in a SIMD register. These registers can hold multiple values packed together, allowing operations on entire vectors or arrays without looping through individual elements. The benefits of SIMD include improved performance for applications that exploit data parallelism and greater energy efficiency, as executing multiple operations in a single instruction cycle reduces the total number of instructions needed, thereby lowering power consumption. Overall, SIMD registers in ARM64 architecture facilitate efficient processing of large datasets, making them ideal for performance-critical applications.

Referring again to FIG. 2, suppose software application 200 is an instance of a structured query language (SQL) application that provides relational database management functionality. In this example, software application 200 is communicating with storage system 202 to provide cloud-based SQL functionality. Suppose software application 200 provides a request (e.g., request 210) to access data (e.g., data portions 212, 214, 216, 218, 220, 222, 224, 226) within storage system 202.

In some implementations, SIMD enhancement process 10 determines 102 that the portion of data is unaligned to byte boundaries. For example, when data is not aligned to byte boundaries (i.e., where the data includes a bit length that is not divisible into bytes (i.e., eight bits)) while packed into a word (e.g., a sixty-four bit word), ARM64 processor 204 is generally unable to process the data using SIMD registers in byte sized portions. Accordingly, the data needs to be unpacked or repacked before further processing. Due to the lack of advanced bit processing instruction of the ARM NEON instruction set, SIMD enhancement process 10 performs bit unpacking using byte shuffling and bit shifting. As natural, unaligned data can cross two bytes even if the data size less than 8 bits, for better efficiency, it is common that unpacking only supports 16 bits target size regardless of the original packed size.

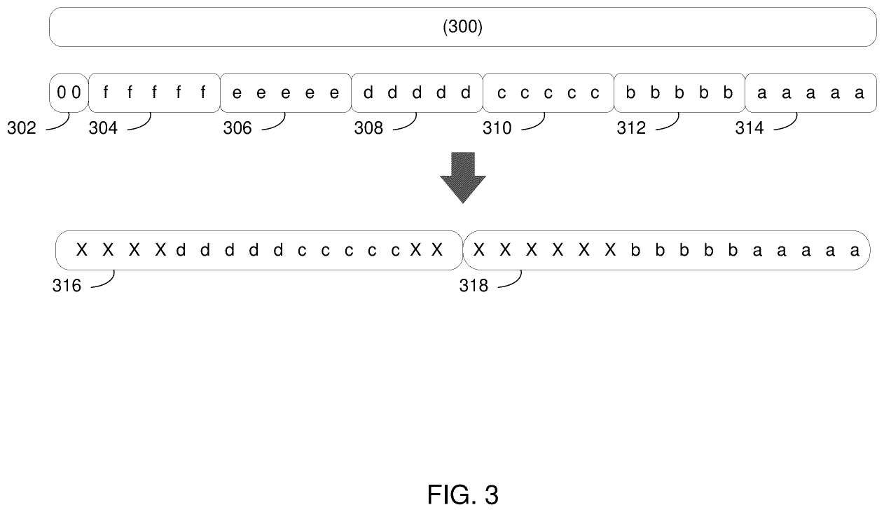

In some implementations, the single multi-bit word is a sixty-four-bit word of the ARM64 processor. For example, SIMD registers 228, 230 include a predefined word size in terms of bit length. In one example, SIMD registers 228, 230 are each 128 bits wide, or two 64-bit words wide. In another example, the single multi-bit word is a thirty-two-bit word of the ARM64 processor. For example and as shown in FIG. 3, data 300 is a thirty-two-bit word that includes bits that are unaligned with 8-bit boundaries (i.e., byte boundaries). However, it will be appreciated that this is for example purposes only as various bit widths may be used within the scope of the present disclosure. SIMD enhancement process 10 determines 102 that data 300 is unaligned to byte boundaries by determining a bit length for data 300. In one example, the bit length is five bits. In another example, the bit length is ten bits. In some implementations, when data 300 is processed by ARM64 processor 204, SIMD enhancement process 10 receives an indication (i.e., metadata associated with data 300) that data 300 is aligned or is unaligned with byte boundaries. As shown in FIG. 3, groupings of bits 302, 304, 306, 308, 310, 312, 314 are shown with grouping 302 including two zero bits; grouping 304 including one set of data (e.g., bits represented by “f f f f f”); grouping 306 including another set of data (e.g., bits represented by “e e e e e”); grouping 308 including another set of data (e.g., bits represented by “d d d d d”); grouping 310 including another set of data (e.g., bits represented by “c c c c c”); grouping 312 including another set of data (e.g., bits represented by “b b b b b”); and grouping 314 including another set of data (e.g., bits represented by “a a a a a”). As these groupings are not byte-length (i.e., eight bits), SIMD enhancement process 10 determines 102 that the portion of data (e.g., data 300) is unaligned with byte boundaries.

In some implementations, SIMD enhancement process 10 unpacks 104 the portion of data from a single multi-bit word into multiple fixed bit output by placing the portion of data at a byte boundary between the multiple fixed bit outputs. As discussed above, the portion of data (e.g., data 300) forms a single multi-bit word (e.g., a thirty-two-bit word as shown in FIG. 3). As data 300 is unaligned with byte boundaries, the sets of data within data 300 are “unpacked” (i.e., breaking down of a larger binary representation into smaller units) from the single multi-bit word into multiple fixed bit outputs. A fixed bit output is a set of bits from the single multi-bit word that has a set or fixed number of bits. In one example, each fixed bit output includes five bits. In another example, each fixed bit output includes ten bits. It will be appreciated that the fixed bit output includes any number of bits that is not divisible by eight or a multiple of eight (i.e., a byte).

In some implementations, unpacking 104 the portion of data includes shuffling 106 the portion of data within the single multi-bit word into the multiple fixed bit outputs. Referring again to FIG. 3, SIMD enhancement process 10 shuffles 106 data 300 into two byte portions (e.g., portion 316 with bits “X X X X d d d d d c c c c c X X” where each “X” represents unwanted data for the final multiple fixed bit output size of five bits and portion 318 with bits “X X X X X X b b b b b a a a a a”).

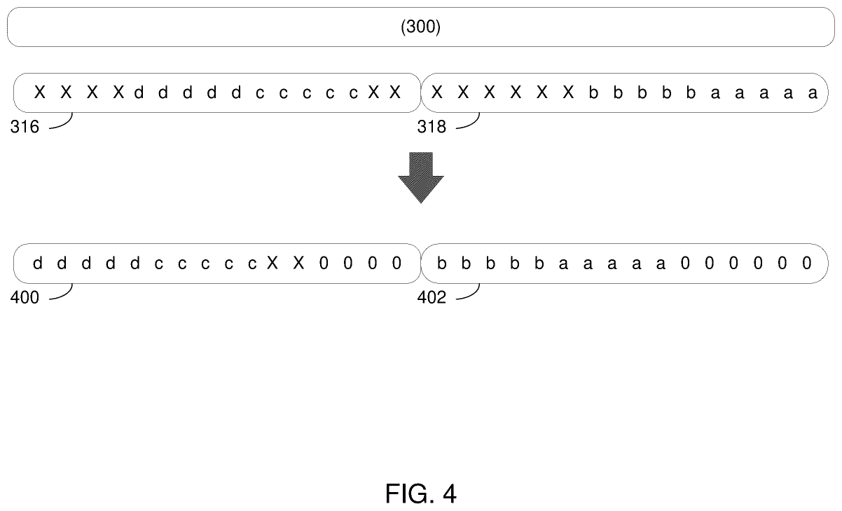

In some implementations, unpacking 104 the portion of data includes: shifting 108 bits within each fixed bit output to top of each output; and trimming 110 a predefined number of unwanted bits from each fixed bit output. For example and as shown in FIG. 4, SIMD enhancement process 10 left shifts 108 portions 316, 318 and trims 110 the unwanted bits (e.g., bits marked as “X”) on the left of each portion (e.g., to generate portions 400, 402, respectively). With the shifting of unwanted bits, zero bits are added to the right of portions 400, 402.

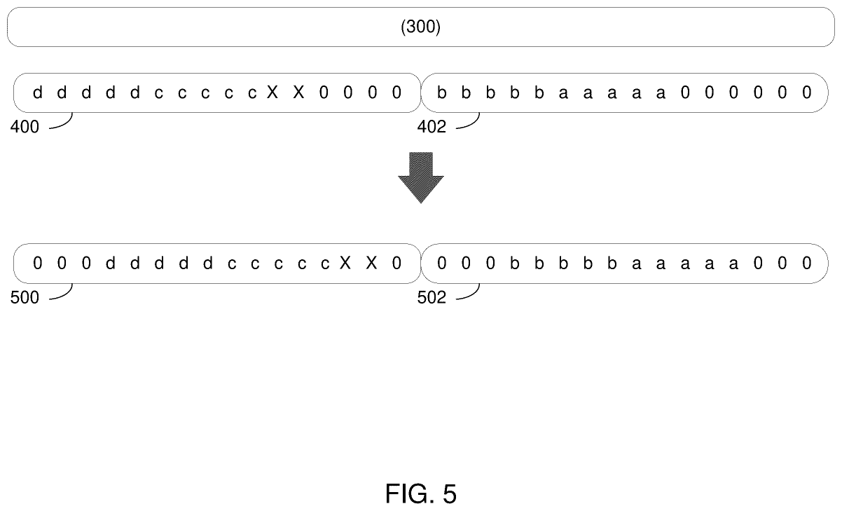

In some implementations, unpacking 104 the portion of data includes shifting 112 bits within each fixed bit output to align at the byte boundary between the fixed bit outputs. For example, SIMD enhancement process 10 right shifts 112 to align the middle-fixed bit output at the byte boundary. Referring also to FIG. 5, SIMD enhancement process 10 right shifts 112 portion 400 to produce portion 500 with zeroes added where bits “d d d d d c c c c X X” are right shifted to the byte boundary of portion 500 (i.e., one byte formed from bits “0 0 0 d d d d d” and a second byte formed from bits “c c c c c X X 0”) and where bits “b b b b b a a a a a 0 0” are right shifted to the byte boundary of portion 502 (i.e., one byte formed from bits “0 0 0 b b b b b” and a second byte formed from bits “a a a a a 0 0 0”). In some implementations, unpacking 104 the portion of data includes shifting 114 bits within each even byte output to an end of the even byte output. For example, SIMD enhancement process 10 performs a secondary right shift to even bytes (i.e., bytes 600 and 602) while bytes 604 and 606 are byte aligned (i.e., with zeroes before fixed bit outputs “d d d d d” and “b b b b b”). Accordingly, SIMD enhancement process 10 generates byte aligned fixed bit outputs in bytes 600, 602, 604, 606 using five bits sets. In this manner, SIMD enhancement process 10 allows SIMD processors 228, 230 of ARM64 processor 204 to process the byte aligned fixed bit outputs. SIMD enhancement process 10 uses the above-described dual unpacking technique to repurpose double size unpacking (2×3 bits, 2×5 bits, 2×6 bits etc.) to unpack double size data for the first half, on purpose placing data at byte boundary to cut in half and split them up. Accordingly, SIMD enhancement process 10 doubles the outputs but improves throughput by 30% or more.

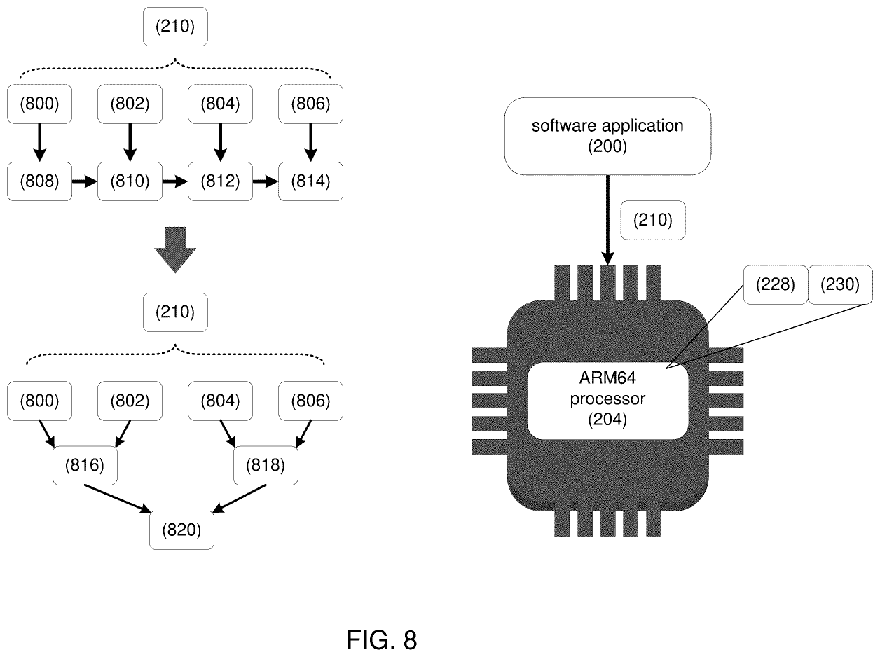

In some implementations, SIMD enhancement process 10 processes 700 a request to access data from a storage system using an ARM64 processor. As discussed above and as shown in FIG. 8, SIMD enhancement process 10 processes 700 a request (e.g., request 210) for accessing data within storage system 202 as shown in FIG. 2. In one example, request 210 is associated with a SQL database software application (e.g., software application 200) for accessing data portions within a database.

In some implementations, SIMD enhancement process 10 identifies 702 a plurality of individual operations within the request. For instance and in this example, request 210 includes an aggregation of multiple individual operations (e.g., finding a minimum or maximum of values; accumulating a sum; determining a population count; etc.). In some implementations, SIMD enhancement process 10 processes 700 request 210 with SIMD registers 228, 230 where each SIMD register includes a contiguous buffer. As opposed to a sequential ordinary for loop, SIMD enhancement process 10 leverages SIMD to divide the buffer into multiple lanes to process data up to vector size in each iteration. Referring again to FIG. 8, request 210 can be performed with sequential aggregation (i.e., where data is combined or summarized in a specific order, often using a series of operations that build upon each previous result). This approach, as shown in FIG. 8 with data portions 800, 802, 804, 806 and individual operations 808, 810, 812, 814, where request 210 is an accumulated sum of data portions 800, 802, 804, 806, allows for efficient computation and can help maintain context in scenarios where the order of data matters, such as time series analysis. In this example, individual operation 808 includes the sum of data portion 800; individual operation 810 includes the sum of data portion 802 to the result of individual operation 808; individual operation 812 includes the sum of data portion 804 to the result of individual operation 810; and individual operation 814 includes the sum of data portion 806 to the result of individual operation 802.

In some implementations, SIMD enhancement process 10 processes 704 the plurality of individual operations using hierarchical aggregation of the plurality of individual operations within a plurality of single instruction, multiple data (SIMD) registers of the ARM64 processor. For example, in contrast to the sequential aggregation, SIMD enhancement process 10 processes 704 the plurality of individual operations (e.g., individual operations 816, 818, 820) using hierarchical aggregation. Hierarchical aggregation is a data summarization technique that organizes and aggregates data at multiple levels of a hierarchy, allowing for insights from various perspectives and granularity levels. For instance, in a sales dataset, one might aggregate data starting from individual sales transactions, then move to daily totals, monthly summaries, quarterly figures, and finally yearly sales. Referring again to FIG. 8, SIMD enhancement process 10 processes the plurality of individual operations (e.g., individual operations 816, 818) by generating the sum of data portions 800 and 802 and by generating the sum of data portions 804 and 806. SIMD enhancement process 10 then processes the sum of the results of individual operations 816 and 818 to produce result 820. In this example, the result of sequential aggregation and hierarchical aggregation is the same.

In some implementations, processing 704 the plurality of individual operations using hierarchical aggregation includes performing 706 a plurality of individual operations in parallel using the plurality of SIMD registers of the ARM64 processor. For example, with hierarchical aggregation, SIMD enhancement process 10 assigns each individual operation for parallel processing as the result of individual operation 816 is not needed to perform individual operation 818 and vice versa. Accordingly, SIMD enhancement process 10 allows SIMD with ARM64 processors by using hierarchical aggregation of individual operations to perform the individual operations in parallel using separate SIMD registers 228, 230 of ARM64 processor 204.

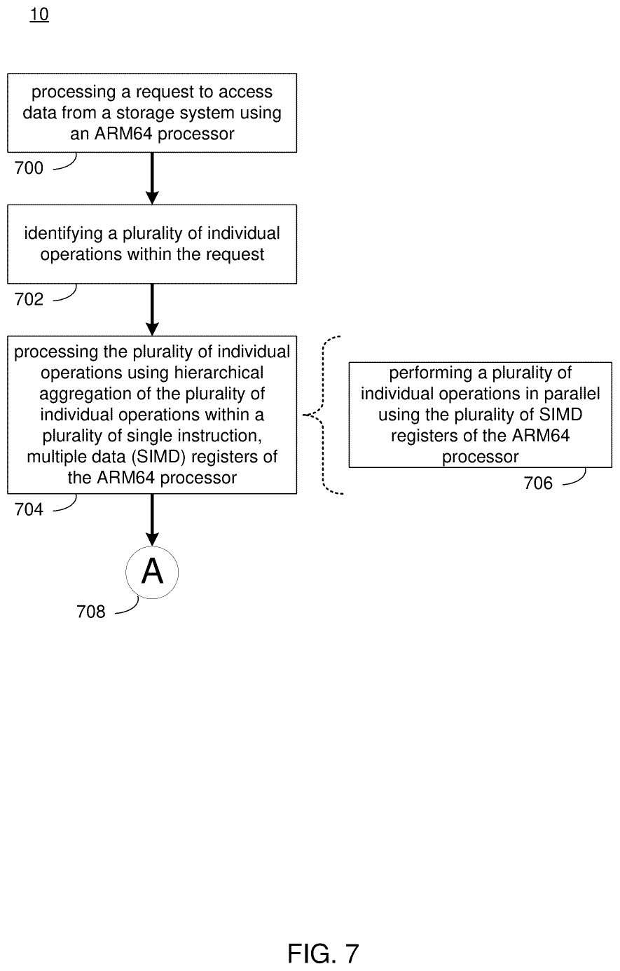

As shown in FIGS. 1 and 7 and as described above, SIMD enhancement process 10 continues or returns (at action 708) to process a portion of data using the ARM64 processor at action 100 and to determine whether the portion of data is unaligned to byte boundaries at action 102.

In some implementations, SIMD enhancement process 10 processes 900 a bitmap defining an address for data within a storage system using an ARM64 processor. For example, regular data addressing provides byte level granularity while a bit level lookup involves processing a bitmap (e.g., bitmap 1000). In one example, a request (e.g., request 210) includes a request to access a particular portion of data within storage system 202. In this example, SIMD enhancement process 10 first processes request 210 to identify a target byte within storage system 202 that includes a desired bit (or bits) and processing a bitmap to identify the relevant bit (or bits).

In some implementations, SIMD enhancement process 10 converts 902 the bitmap to a bytemap within a single instruction, multiple data (SIMD) register of the ARM64 processor. For example, SIMD enhancement process 10 converts 902 bitmap 1000 to a bytemap (e.g., bytemap 1002) by converting all zeros or all ones to present one bit in a byte. Suppose bitmap 1000 includes the following bits: “0011:0110:0101:1111”. In this example, SIMD enhancement process 10 converts 902 to bytemap 1002 by converting each bit as follows: “00 00 FF FF:00 FF FF 00:00 FF 00 FF:FF FF FF FF”. In some implementations, SIMD enhancement process 10 converts bitmap 1000 to bytemap 1002 in advance (i.e., before processing request 210) such that the lookup requires only one action (i.e., locating a corresponding byte from request 210 within bytemap 1002).

In some implementations, SIMD enhancement process 10 processes 904 a request to access the data by using the bytemap to identify the address for the data within the storage system. For example, SIMD enhancement process 10 provides bytemap 1002 to SIMD registers 228, 230 for processing of request 210. When processing 904 request 210, SIMD enhancement process 10 accesses SIMD registers 228, 230 and bytemap 1002 to identify the address for the data within storage system 202.

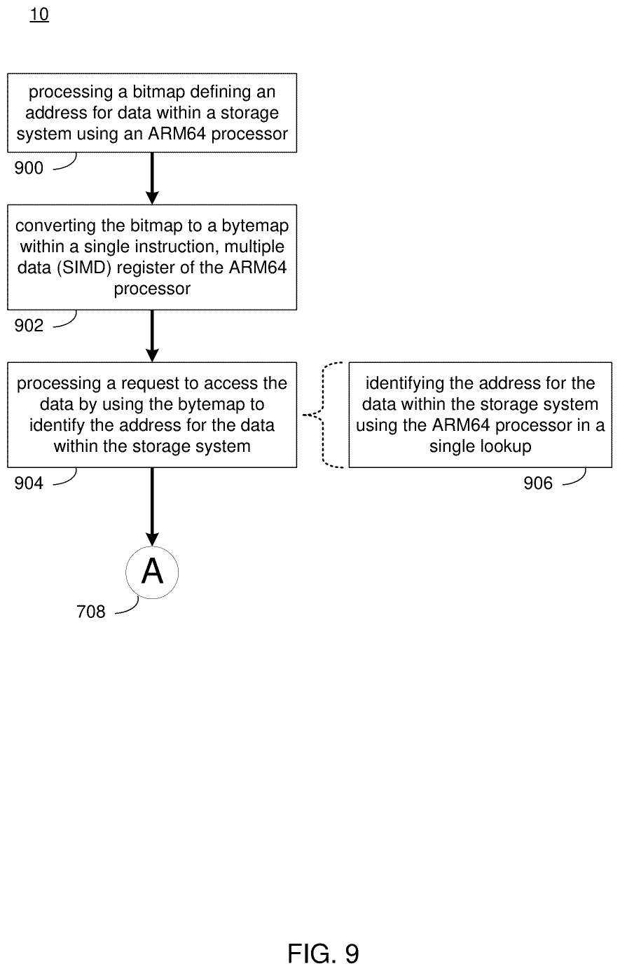

In some implementations, processing 904 the request to access the data by using the bytemap includes identifying 906 the address for the data within the storage system using the ARM64 processor in a single lookup. For example, by loading converted bitmap to bytemap into SIMD register(s) and performing lookup via SIMD instruction not only allowing bitmap lookup in parallel, also minimize the lookup overhead and in most can be 20 times faster than scalar implementations. As shown in FIGS. 1 and 9 and as described above, SIMD enhancement process 10 continues or returns (at action 708) to process the data using the ARM64 processor at action 100 and to determine whether the portion of data is unaligned to byte boundaries at action 102.

### System Overview

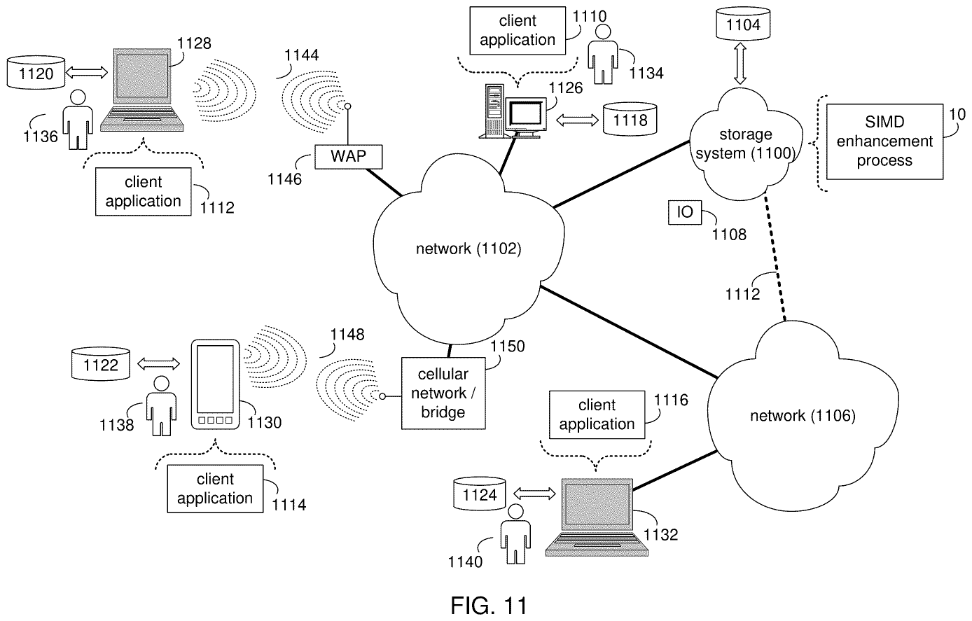

Referring to FIG. 11, a SIMD enhancement process 10 is shown to reside on and is executed by storage system 1100, which is connected to network 1102 (e.g., the Internet or a local area network). Examples of storage system 1100 include: a Network Attached Storage (NAS) system, a Storage Area Network (SAN), a personal computer with a memory system, a server computer with a memory system, and a cloud-based device with a memory system. A SAN includes one or more of a personal computer, a server computer, a series of server computers, a minicomputer, a mainframe computer, a RAID device, and a NAS system.

The various components of storage system 1100 execute one or more operating systems, examples of which include: Microsoft® Windows®; Mac® OS X®; Red Hat® Linux®, Windows® Mobile, Chrome OS, Blackberry OS, Fire OS, or a custom operating system (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of SIMD enhancement process 10, which are stored on storage device 1104 included within storage system 1100, are executed by one or more processors (not shown) and one or more memory architectures (not shown) included within storage system 1100. Storage device 1104 may include: a hard disk drive; an optical drive; a RAID device; a random-access memory (RAM); a read-only memory (ROM); and all forms of flash memory storage devices. Additionally or alternatively, some portions of the instruction sets and subroutines of SIMD enhancement process 10 are stored on storage devices (and/or executed by processors and memory architectures) that are external to storage system 1100.

In some implementations, network 1102 is connected to one or more secondary networks (e.g., network 1106), examples of which include: a local area network; a wide area network; or an intranet.

Various input/output (IO) requests (e.g., IO request 1108) are sent from client applications 1110, 1112, 1114, 1116 to storage system 1100. Examples of IO request 1108 include data write requests (e.g., a request that content be written to storage system 1100) and data read requests (e.g., a request that content be read from storage system 1100).

The instruction sets and subroutines of client applications 1110, 1112, 1114, 1116, which may be stored on storage devices 1118, 1120, 1122, 1124 (respectively) coupled to client electronic devices 1126, 1128, 1130, 1132 (respectively), may be executed by one or more processors (not shown) and one or more memory architectures (not shown) incorporated into client electronic devices 1126, 1128, 1130, 1132 (respectively). Storage devices 1118, 1120, 1122, 1124 may include: hard disk drives; tape drives; optical drives; RAID devices; random access memories (RAM); read-only memories (ROM), and all forms of flash memory storage devices. Examples of client electronic devices 1126, 1128, 1130, 1132 include personal computer 1126, laptop computer 1128, smartphone 1130, laptop computer 1132, a server (not shown), a data-enabled, and a dedicated network device (not shown). Client electronic devices 1126, 1128, 1130, 1132 each execute an operating system.

Users 1134, 1136, 1138, 1140 may access storage system 1100 directly through network 1102 or through secondary network 1106. Further, storage system 1100 may be connected to network 1102 through secondary network 1106, as illustrated with link line 1142.

The various client electronic devices may be directly or indirectly coupled to network 1102 (or network 1106). For example, personal computer 1126 is shown directly coupled to network 1102 via a hardwired network connection. Further, laptop computer 1132 is shown directly coupled to network 1106 via a hardwired network connection. Laptop computer 1128 is shown wirelessly coupled to network 1102 via wireless communication channel 1144 established between laptop computer 1128 and wireless access point (e.g., WAP) 1146, which is shown directly coupled to network 1102. WAP 1146 may be, for example, an IEEE 802.11a, 802.11b, 802.11g, 802.11n, Wi-Fi®, and/or Bluetooth® device that is capable of establishing a wireless communication channel 1144 between laptop computer 1128 and WAP 1146. Smartphone 1130 is shown wirelessly coupled to network 1102 via wireless communication channel 1148 established between smartphone 1130 and cellular network/bridge 1150, which is shown directly coupled to network 1102.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

1-14. (canceled)

15. A non-transitory computer readable medium having a plurality of instructions stored thereon which, when executed by a processor, cause the processor to:
process a bitmap defining an address for data within a storage system using an ARM64 processor;
convert the bitmap to a bytemap within a single instruction, multiple data (SIMD) register of the ARM64 processor; and
process a request to access the data by using the bytemap to identify the address for the data within the storage system.

16. The non-transitory computer readable medium of claim 15, wherein to process the request to access the data by using the bytemap the processor is to identify the address for the data within the storage system using the ARM64 processor in a single lookup.

17. The non-transitory computer readable medium of claim 15, wherein the processor is further to
determine that the data is unaligned to byte boundaries; and
unpack the data from a single multi-bit word into multiple fixed bit output by placing the data at a byte boundary between the multiple fixed bit outputs.

18. The non-transitory computer readable medium of claim 17, wherein to unpack the data the processor is to shuffle the data within the single multi-bit word into the multiple fixed bit outputs.

19. The non-transitory computer readable medium of claim 18, wherein to unpack the data the processor is to:
shift bits within each fixed bit output to top of each output; and
trim a predefined number of unwanted bits from each fixed bit output.

20. The non-transitory computer readable medium of claim 15, wherein the processor is further to:
identify a plurality of individual operations within the request; and
process the plurality of individual operations using hierarchical aggregation of the plurality of individual operations within a plurality of single instruction, multiple data (SIMD) registers of the ARM64 processor.

21. A method comprising:
processing a bitmap defining an address for data within a storage system using an ARM64 processor;
converting the bitmap to a bytemap within a single instruction, multiple data (SIMD) register of the ARM64 processor; and
processing a request to access the data by using the bytemap to identify the address for the data within the storage system.

22. The method of claim 21, wherein processing the request to access the data by using the bytemap comprises identifying the address for the data within the storage system using the ARM64 processor in a single lookup.

23. The method of claim 21, further comprising:
determining that the data is unaligned to byte boundaries; and
unpacking the data from a single multi-bit word into multiple fixed bit output by placing the data at a byte boundary between the multiple fixed bit outputs.

24. The method of claim 23, wherein unpacking the data comprises shuffling the data within the single multi-bit word into the multiple fixed bit outputs.

25. The method of claim 24, wherein unpacking the data comprises:
shifting bits within each fixed bit output to top of each output; and
trimming a predefined number of unwanted bits from each fixed bit output.

26. The method of claim 21, further comprising:
identifying a plurality of individual operations within the request; and processing the plurality of individual operations using hierarchical aggregation of the plurality of individual operations within a plurality of single instruction, multiple data (SIMD) registers of the ARM64 processor.

27. A system comprising:
a memory; and
a processor operatively coupled to the memory, the processor to:
process a bitmap defining an address for data within a storage system using an ARM64 processor;
convert the bitmap to a bytemap within a single instruction, multiple data (SIMD) register of the ARM64 processor; and
process a request to access the data by using the bytemap to identify the address for the data within the storage system.

28. The system of claim 27, wherein to process the request to access the data by using the bytemap the processor is to identify the address for the data within the storage system using the ARM64 processor in a single lookup.

29. The system of claim 27, wherein the processor is further to:
determine that the data is unaligned to byte boundaries; and
unpack the data from a single multi-bit word into multiple fixed bit output by placing the data at a byte boundary between the multiple fixed bit outputs.

30. The system of claim 29, wherein to unpack the data the processor is to shuffle the data within the single multi-bit word into the multiple fixed bit outputs.

31. The system of claim 30, wherein to unpack the data the processor is to:
shift bits within each fixed bit output to top of each output; and
trim a predefined number of unwanted bits from each fixed bit output.

32. The system of claim 27, wherein the processor is further to:
identify a plurality of individual operations within the request; and processing the plurality of individual operations using hierarchical aggregation of the plurality of individual operations within a plurality of single instruction, multiple data (SIMD) registers of the ARM64 processor.
